(19) United States
(12) Patent Application Publication
(10) Pub. No.: US 2007/0240467 A1
(43) Pub. Date: Oct. 18, 2007

(54) Removable thumb turn attachment

(76) Inventors: Lus Morisset, Upland, CA (US); Kevin Cooper, Belleflower, CA (US)

Correspondence Address: Karl M. Steins;Steins & Associates, Suite 120, 2333 Camino del Rio South, San Diego, CA, 92108, US

(21) Appl. No.: 11/404,141

(22) Filed: Apr. 13, 2006

(51) Int. Cl. E05B 13/00

(52) U.S. Cl. 70/416

(57) ABSTRACT

A Removable Thumb Turn Attachment is disclosed. The device and system incorporate a thumb turn cap that is attachable to the head of a conventional deadbolt key. The system may include a retaining cap assembly that is installable over a conventional deadbolt lockset. The retaining cap assembly cooperates with the thumb turn cap so that the thumb turn cap will engage the retaining cap assembly so that the thumb turn cap, once inserted, cannot be readily removed from the retaining cap assembly. The thumb turn cap and retaining cap are installable on a conventional key-operated deadbolt lockset so that the lockset is converted to operate as a thumb-turn-operated deadbolt lockset.

### BACKGROUND OF THE INVENTION

1. Field of the Invention

This invention relates generally to tamper-proof seals for containers and, more specifically, to a Removable Thumb Turn Attachment.

2. Description of Related Art

Deadbolt locksets are extremely common pieces of security equipment that can be found on virtually any entrance door found in a domicile. The deadbolt locksets are intended to back up the main lockset that is either knob, lever, or button-actuated, to provide a second level of lock security to entrance doors. The two common versions of deadbolt locksets are depicted in FIGS. 1A and 1B. FIG. 1A is a perspective view of a conventional key-operated deadbolt lockset 10A. The lockset 10A has an exterior lock cylinder subassembly 12 (protruding on the outer side of the door 11) and an interior lock cylinder subassembly 14A. On the key-operated type of lockset, the interior lock cylinder subassembly is actuated by a key 20 inserted into the key slot 18 and turned.

The key-operated deadbolt lockset 10A is intended to provide the most superior security to the occupant. If used as intended, the occupant will not keep the key 20 inserted into the key slot 18 on a regular basis, but rather will only insert the key 20 when actually locking the deadbolt. The key 20 should then be removed and placed away from the door 11. If this process is followed, an intruder would not be able to break out a window within the door to reach the key 20 (that is still in the key slot), because the key 20 wouldn't be there.

Unfortunately, the typical occupant does not follow this process, but rather leaves the key 20 inserted into the key slot 18 at all times for convenience. Furthermore, a truly crafty intruder could gain access to the domicile innocently, and then remove the key 20 from the deadbolt 10A at an opportune moment. Now the intruder can return and gain entry to the domicile using the occupant's own key.

FIG. 1B is a perspective view of the other type of conventional deadbolt lock set—the thumb turn-operated lockset 10B. Instead of having a key, this type of lockset 10B has a permanently-attached thumb turn 22 or knob extending from the interior lock cylinder subassembly 14B. The thumb turn 22 provides very convenient operation to the occupant, but is really only suitable for entry doors having no windows built into them, or in close proximity to the door. What is needed is a deadbolt actuating system that has the strengths of both the key-operated deadbolt lockset as well as the thumb turn-operated lockset. For reference later in this specification, the specific elements of the prior device will be more fully described herein.

FIG. 2 is a side view of a conventional key-operated deadbolt lockset 10A. The lockset 10A, as discussed above, has an exterior lock cylinder subassembly 12 and an interior lock cylinder subassembly 14. Both subassemblies 12 and 14 have key slots 18 formed within them for accepting the same key 20 for operating the lockset 10A.

The exterior lock cylinder subassembly 12 is substantially encased within a decorative and protective exterior collar 26, typically conical in shape. The interior lock cylinder subassembly 14 is encased within a conical interior collar 24.

FIG. 3 is a front view of the key-operated deadbolt lockset 10A of FIGS. 1A and 2. The interior collar 24 transitions into a substantially flat face 28 that is parallel to the interior surface of the door 11. The key slot 18 is actually formed within the lock cylinder 30 (the part that turns when the lockset is locked or unlocked). The lock cylinder 30 protrudes through a hole formed in the face 28 so that the face 28 and collar 24 remain stationary while the key slot 18 and lock cylinder 30 rotate. Typically, the entire interior lock cylinder assembly 14A is attached to the door 11 by a pair of decorative mounting screws 32 threaded through a pair of matching apertures formed in the face 28 of the collar 24.

### SUMMARY OF THE INVENTION

In light of the aforementioned problems associated with the prior devices and systems, it is an object of the present invention to provide a Removable Thumb Turn Attachment. The device and system should incorporate a thumb turn cap that is attachable to the head of a conventional deadbolt key. The system may include a retaining cap assembly that is installable over a conventional deadbolt lockset. The retaining cap assembly should cooperate with the thumb turn cap so that the thumb turn cap will engage the retaining cap assembly so that the thumb turn cap, once inserted, cannot be readily removed from the retaining cap assembly. The thumb turn cap and retaining cap should be installable on a conventional key-operated deadbolt lockset so that the lockset is converted to operate as a thumb-turn-operated deadbolt lockset.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings, of which:

FIGS. 1A and 1B are perspective views of two commonly-available versions of deadbolt locksets;

FIG. 2 is a side view of a conventional key-operated deadbolt lockset;

FIG. 3 is a front view of the interior lock cylinder subassembly of the lockset of FIG. 2;

FIG. 4 is a side view of the key-operated deadbolt lockset of FIG. 2 having a preferred embodiment of the thumb turn conversion assembly of the present invention installed thereon;

FIG. 5 is a perspective view of the retaining cap assembly of the assembly of FIG. 4;

FIGS. 6A and 6B are perspective views of snap-in thumb turn cap of the assembly of FIG. 4;

FIG. 7 is a partial cutaway side view of the snap-in thumb turn cap of FIGS. 6A and 6B; and

FIG. 8 is a partial exploded cutaway side view of the assembly of FIG. 4.

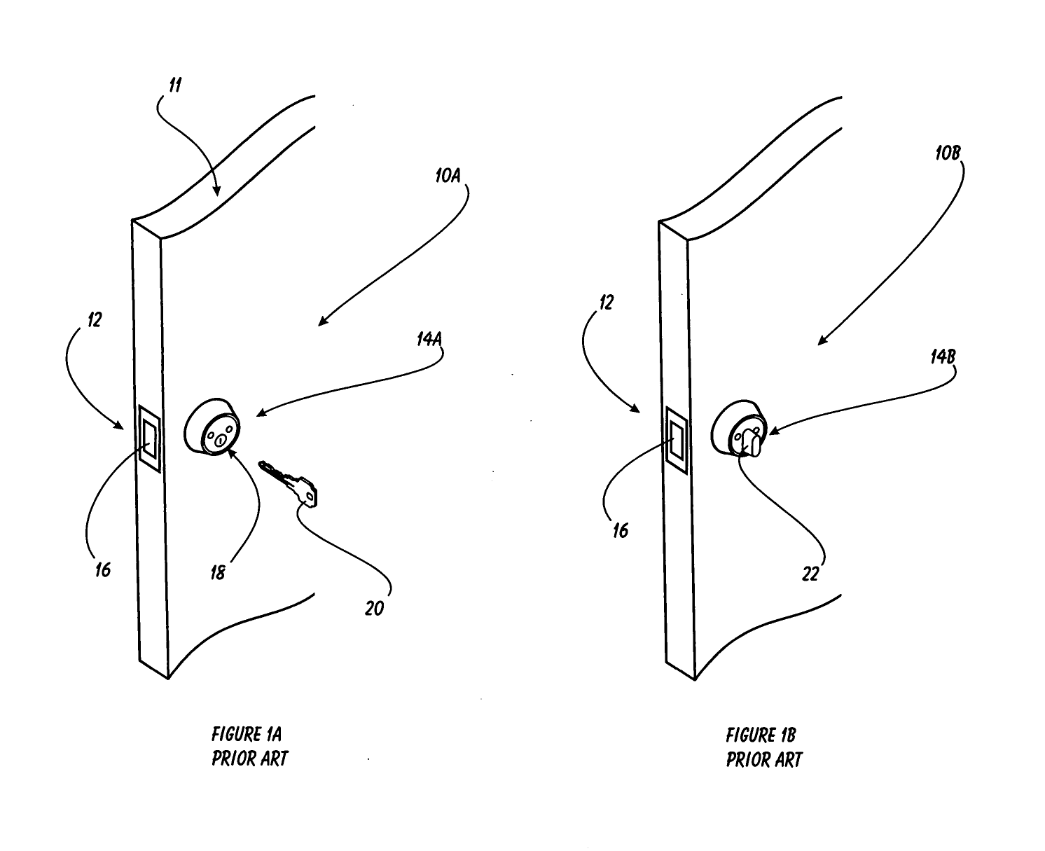

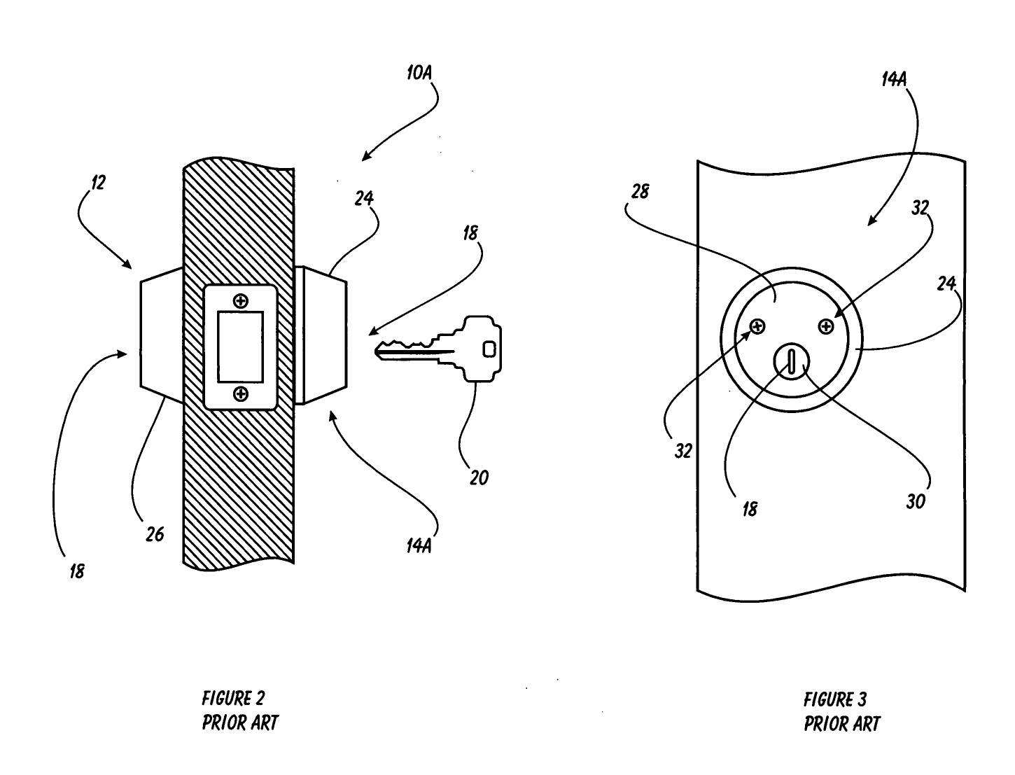

### DETAILED DESCRIPTION OF THE PREFERRED EMBODIMENTS

The following description is provided to enable any person skilled in the art to make and use the invention and sets forth the best modes contemplated by the inventors of carrying out their invention. Various modifications, however, will remain readily apparent to those skilled in the art, since the generic principles of the present invention have been defined herein specifically to provide a Removable Thumb Turn Attachment.

The present invention can best be understood by initial consideration of FIG. 4. FIG. 4 is a side view of the key-operated deadbolt lockset of FIG. 2 having a preferred embodiment of the thumb turn conversion assembly 40 of the present invention installed thereon. One substantial benefit of the present invention is that it is specifically configured to attach to a standard key-operated deadbolt lockset without the need for alteration of any of the components.

The assembly 40 comprises two major components: The retaining cap assembly 42 and the snap-in thumb turn cap 44. The retaining cap assembly 42 has a collar cap portion 45 which encapsulates the outer profile of the interior collar 24 of the lockset. The retaining cap assembly 42 has a retaining tube 46 extending inwardly from the face of the lockset such that the inner bore of the tube 46 is positioned over the key slot in the lockset.

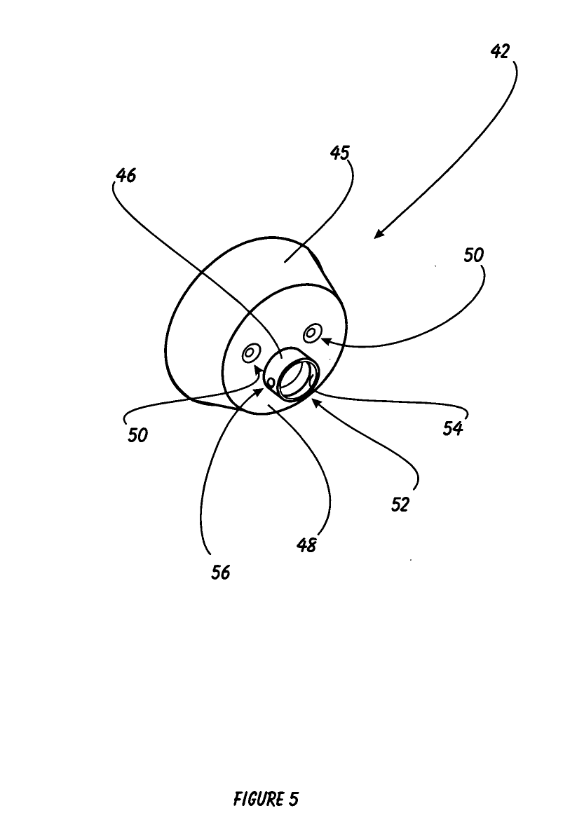

The second component of the assembly 40 is the snap-in thumb turn cap 44. The cap 44 is designed to accept a standard deadbolt key 20 within it, such that the head of the key 20 is completely encapsulated within the knob 48 of the cap 44. The keyed portion of the key 20 (and other critical portions of the cap 44) extend within the internal bore formed by the retaining tube 46. As will be discussed more fully below, the assembly 42 and the cap 44 cooperate such that when the key 20 and portions of the cap 44 are engaged fully with the assembly 42 (and the key 20 with the lockset), the cap 44/key 20 assembly will be restrained from being removed by the assembly 42 (which is attached to the door 11). As a result, a standard key-operated deadbolt lockset is converted into a thumb turn-operated lockset. The difference here is that (as will be discussed below) the cap 44/key 20 is easily removable by a user having the proper tool and knowledge. As such, the thumb turn can be removed from the deadbolt lockset for added security. If we now turn to FIG. 5, we can examine one of the critical components of the assembly 40 of the present invention.

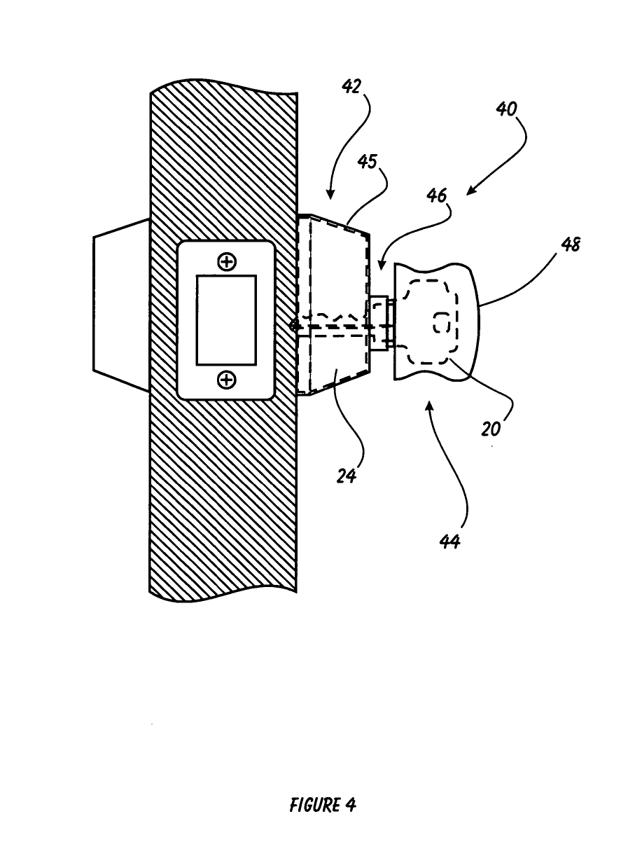

FIG. 5 is a perspective view of the retaining cap assembly 42 of the assembly 40 of FIG. 4. The assembly 42 has a collar cap portion 45 is essentially a hollow conical shape having an opening on the door-facing side, and transitioning into a substantially flat face portion 48 enclosing its opposing side. The retaining tube 46 extends outwardly from the interior-facing surface of the face portion 48, to form the side boundaries of a key bore 52. The tube 46 is positioned so that it is centered over the cylinder and key slot of the lockset (see FIG. 3), so that a key tip inserted into the key bore 52 can reach the key slot provided in the lockset. Furthermore, the distal edge of the tube 46 has a retaining lip 54 formed around its periphery. As will become clear below, the retaining lip 54 is provided to cooperate with a feature extending from the thumb turn cap 44 to prevent the thumb turn cap 44 from being withdrawn away from the retaining cap assembly 42 once the thumb turn cap 44 has been snapped in. The retaining tube 46 also has a release aperture 56 formed through its wall. The aforementioned engaging element on the thumb turn cap can be depressed by a tool inserted through the release aperture 46 (when the thumb turn cap is rotationally positioned properly so that the key can release from the cylinder).

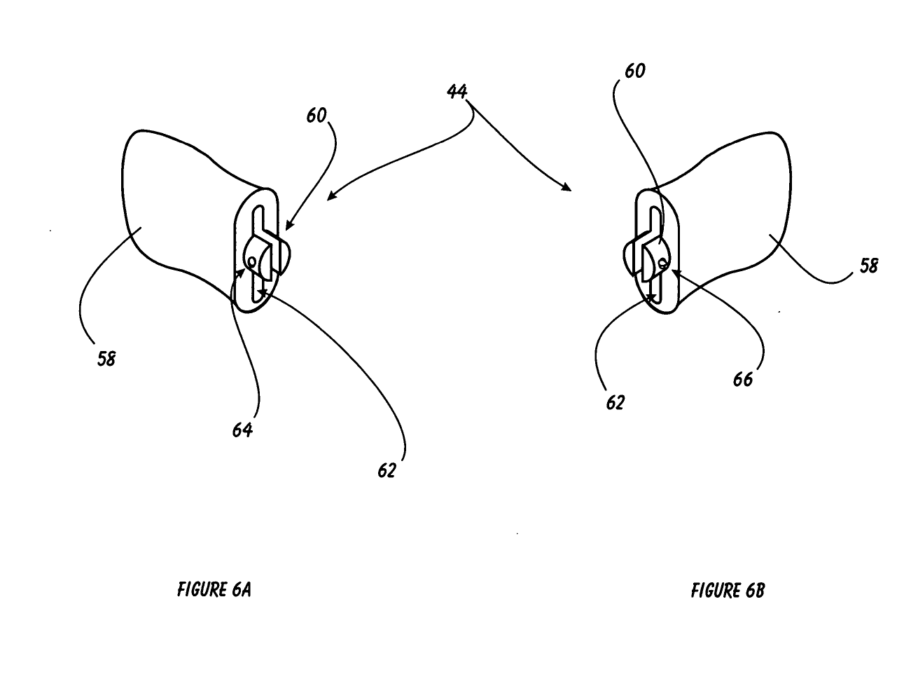

The face portion 48 further has a pair of screw apertures 50 formed through it. The screw apertures 50 are positioned so that they align with the mounting screws in the conventional deadbolt lockset (see FIG. 3). The retaining cap assembly 42 has a pleasing aesthetic appearance, so that it will not detract from the appearance of the door and lockset. If we now turn to FIGS. 6A and 6B, we can examine the elements of the other major component of the assembly 40 of the present invention.

FIGS. 6A and 6B are perspective views of snap-in thumb turn cap 44 of the assembly 40 of FIG. 4. The cap 44 has a knob 58 which has an ergonomic outer shape so that it is comfortably operable as well as being aesthetically pleasing. A stem 60 extends from the knob 58. The outer circumference of the stem 60 is sized and shaped such that it will insert into the retaining bore (see FIG. 5) when the key (having the cap 44 attached to it) is inserted into the lockset cylinder.

The cap 44 has a key head slot 62 cut into it. The slot 62 is formed in the knob 58 and the stem 60, and is sized to fit the typical sizes and shapes of heads of keys. A set screw 64 is threadedly engaged with the stem 60 so that it can be tightened down once a key head has been inserted into the slot 62 in order to securely bind the cap 44 to the key. On the opposing side of the stem 60, a retaining finger 66 extends outwardly from the side of the stem 60. In this version, the finger 66 is spring-biased outwardly through a hole formed in the outer wall of the stem 60, but in other versions, the same function may be served by a ball-detent, or even a thin-walled, depressible “bump” formed in the wall of the stem 60. In any case, the location of the retaining finger 66 cooperates with the release aperture in the retaining tube of the retaining cap assembly so that when the key/thumb turn cap 44 is inserted into the key slot, the retaining finger 66 and the release aperture are in alignment. Because of this cooperation, when the retaining finger 66 is snapped in under the retaining lip formed in the retaining tube, the only way that the key/thumb turn cap 44 can be removed is to turn the key until it is in the insert/remove position, with the retaining finger 66 aligned with the release aperture. A tool, such as a paperclip, can be inserted into the aperture in the retaining tube until it depresses the finger 66. Once depressed until it releases from behind the retaining lip, the finger 66 will allow the key to be withdrawn from the key slot.

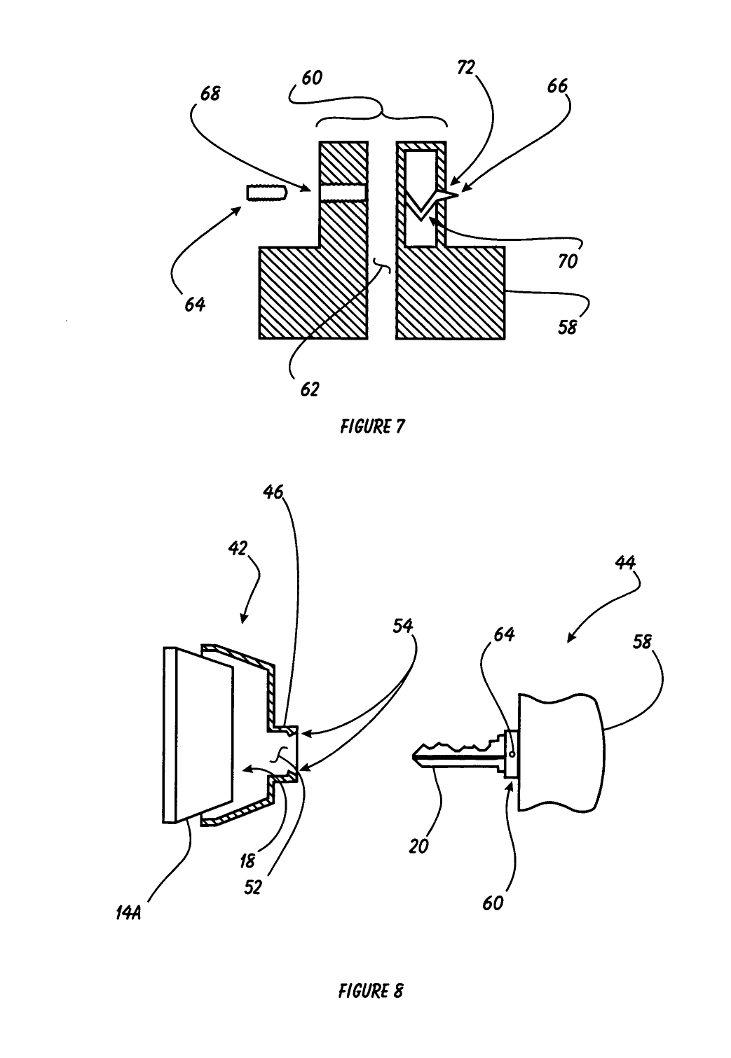

In a simplified embodiment, the thumb turn cap 44 will not incorporate the retaining finger 66, but will have the set screw 64 for securing the cap 44 to a key head. Without the retaining finger 66, the key/cap will not be locked into the deadbolt, but it will serve to convert a conventional key-operated deadbolt to a thumb-turn-operated deadbolt. The stem 60 detail is more easily understood by review of FIG. 7.

FIG. 7 is a partial cutaway side view of the snap-in thumb turn cap 44 of FIGS. 6A and 6B. As shown here, the set screw 64 threadedly engages a threaded bore 68 formed in one side of the stem 60. The set screw 64 can be turned until its tip engages the key inserted into the key head slot 62 formed between the two halves of the stem 60.

The retaining finger 66 in this version has a biasing member 70 in the sidewall of the other half of the stem 60. The finger 66 is biased outwardly through the hole 72 formed in the side of the stem 60. If we finally turn to FIG. 8, we can see how the two components of the assembly of the present invention interact.

FIG. 8 is a partial exploded cutaway side view of the assembly 40 of FIG. 4. After removing the mounting screws from the interior lock cylinder subassembly 14A, the retaining cap assembly 42 is placed over it, and the mounting screws are reinserted through the screw apertures (50, see FIG. 5), and into the face 28 of the subassembly 14A, and tightened until the assembly 42 is securely attached to the subassembly 14A.

The key bore 52 is now positioned over the key slot 18, so that the key 20 (held within the cap 44) can be inserted therein until the key is fully inserted into the lockset. When inserted, the retaining finger (not shown) will engage the retaining lip 54, which will prevent the cap 44/key 20 from being removed from the retaining tube 46. When the user wishes to remove the cap 44/key 20, the knob 58 need simply be turned until the key 20 is in the upright (released) position, and the retaining finger (not shown) is aligned with the release aperture (not shown). A tool inserted through the release aperture (not shown) to depress the retaining finger (not shown) will release the retaining finger (not shown) from the lip 54, and the key 20 will be removable.

Those skilled in the art will appreciate that various adaptations and modifications of the just-described preferred embodiment can be configured without departing from the scope and spirit of the invention. Therefore, it is to be understood that, within the scope of the appended claims, the invention may be practiced other than as specifically described herein.

What is claimed is:

1. A thumb turn conversion assembly for converting a key-operated deadbolt lockset into a thumb turn-operated deadbolt lockset, the key-operated deadbolt lockset comprising an interior lock cylinder subassembly having a key slot formed in a face, the assembly comprising:
a retaining cap assembly configured to be attachable to cover said face and key slot of said lockset, said retaining cap assembly further comprising a retaining tube defining a key bore positioned over said key slot when said retaining cap assembly is attached to cover said face; and
a thumb turn cap and key assembly, said key defining a head, said head inserted into a slot formed in said thumb turn cap, said thumb turn cap having a knob and a stem extending therefrom, said stem formed to be insertible into said key bore.

2. The assembly of claim 1, wherein said retaining tube defines a tubular shape having a wall bounding said key bore, said tube originating at a face portion formed in said retaining cap assembly and said tube terminating in a distal end, said distal end having a mouth, said tube further comprising a retaining lip adjacent to, and substantially encircling said mouth.

3. The assembly of claim 2, wherein said retaining cap assembly further comprises a collar cap portion, said collar cap portion comprising a hollow shell having an open first end configured to accept said interior lock cylinder subassembly therethrough, said collar cap portion terminating in said face portion.

4. The assembly of claim 3, wherein said face portion further comprises at least one mounting screw apertures formed therethrough, each said mounting screw aperture positioned to align with one mounting screw on said subassembly face when said retaining cap assembly is attached to said subassembly.

5. The assembly of claim 4, wherein said retaining tube further comprises a release aperture formed through said wall.

6. The assembly of claim 5, wherein said stem of said thumb turn cap comprises a pair of stem-halves, one said stem-half having a threaded bore formed therethrough, said thumb turn cap further comprising a set screw threadedly engaging said threaded bore.

7. The assembly of claim 6, wherein said stem further comprises a second said stem-half, said second stem-half comprising a retaining finger extending therefrom.

8. The assembly of claim 7, wherein said retaining finger and said retaining lip are cooperatively configured such that when said stem is sufficiently inserted into said key bore, said retaining finger will engage said retaining lip to prevent said stem from being removed from said key bore.

9. A cap for a key, said key having a keyed portion and a head, the cap comprising:
a knob and a generally cylindrical stem extending therefrom, said stem and said knob having a key slot formed therein to accept said head of said key.

10. The cap of claim 9, wherein said stem of said cap comprises a pair of stem-halves, one said stem-half having a threaded bore formed therethrough, said thumb turn cap further comprising a set screw threadedly engaging said threaded bore.

11. The cap of claim 10, wherein said stem further comprises a second said stem-half, said second stem-half comprising a retaining finger extending therefrom.

12. The cap of claim 11, wherein said stem further comprises a hole formed in a wall of said second stem-half, said retaining finger biased through said hole by a biasing member associated with said second stem-half.

13. A retaining cap assembly for covering a key-operated deadbolt lockset, the key-operated deadbolt lockset comprising an interior lock cylinder subassembly having a key slot formed in a face, the assembly configured to be attachable to cover said face and key slot of said lockset, said retaining cap assembly further comprising a retaining tube defining a key bore positioned over said key slot when said retaining cap assembly is attached to cover said face.

14. The assembly of claim 13, wherein said retaining tube defines a tubular shape having a wall bounding said key bore, said tube originating at a face portion formed in said retaining cap assembly and said tube terminating in a distal end, said distal end having a mouth, said tube further comprising a retaining lip adjacent to, and substantially encircling said mouth.

15. The assembly of claim 14, wherein said retaining cap assembly further comprises a collar cap portion, said collar cap portion comprising a hollow shell having an open first end configured to accept said interior lock cylinder subassembly therethrough, said collar cap portion terminating in said face portion.

16. The assembly of claim 15, wherein said face portion further comprises at least one mounting screw apertures formed therethrough, each said mounting screw aperture positioned to align with one mounting screw on said subassembly face when said retaining cap assembly is attached to said subassembly.

17. The assembly of claim 16, wherein said retaining tube further comprises a release aperture formed through said wall.
